(19) United States
(12) Patent Application Publication
(10) Pub. No.: US 2006/0017799 A1
(43) Pub. Date: Jan. 26, 2006

(54) Flexible media magnetic laser printer

(76) Inventor: Manish Sharma, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/897,553

(22) Filed: Jul. 23, 2004

(51) Int. Cl. B41J 2/45

(52) U.S. Cl. 347/238

(57) ABSTRACT

A flexible media magnetic laser printing system. In a particular embodiment, the system includes case and a laser printing device disposed at least partially within the case. The laser printer device includes a print material applicator and a fuser. At least one reservoir of magnetic print material is coupled to the print material applicator. The magnetic print material including magnetic particles capable of supporting high density data. In addition, at least one magnetic write device is disposed at least partially within the case proximate to the fuser, opposite from the print material applicator.

### FIELD OF THE INVENTION

The present invention relates generally to data storage and in particular to a laser printer system applying magnetic print material to flexible media such as cloth or paper.

### BACKGROUND

Today's computer systems are becoming increasingly sophisticated, permitting users to perform an ever increasing variety of computing tasks at faster and faster rates. Data storage and retrieval are two issues involved in nearly every computer operation.

Hard copy and soft copy are terms generally applied to distinguish between printed materials and electronic copies. To be non-volatile, the soft copy/electronic copy is traditionally stored in an appropriate data storage media.

Traditional forms of electronic data storage rely upon writing media set down with rigid devices, such as the magnetic media utilized in hard drives, floppy drives and magnetic tape. In a great many instances, a printed representation of the stored data is created, for example, in a textual document, graphic, chart, table or photograph.

Unlike a computer, a printed document does not require a continuous source of power to be enjoyed. Documents printed on paper are also portable and easily passed from one person to another. Yet, in many instances it is desirable to provide the recipient of a hard copy with the corresponding electronic soft copy as well. At least two issues arise in such a setting.

First, the provider of the data must have at his or her disposal an appropriate media for receiving the electronic copy of the information—a removable hard drive, floppy disc, cassette tape, writeable DVD or CD, zip drive, ram drive or other physical device capable of holding electronic data.

In most cases, such devices are acquired for a price from a third party supplier or manufacturer. Regardless of a desire to do so, the general user is not capable of rendering a data storage device on his or her own.

The manufacturing costs and technology involved in fabrication place the generation of traditional data storage devices out of the realm of financial feasibility for the typical user. Although costs for general storage devices have decreased, a user may incur significant aggregate costs over time in continuously utilizing electronic file storage devices.

Second, transferring a second item (i.e., the device containing the electronic copy) in addition to the paper hard copy presents its own problems. The recipient should take care not to loose or misplace the electronic copy. Yet, in many cases the electronic copy is not stored, carried with, or otherwise tied to the paper copy. Frequently, paper and electronic copies are stored in physically different archives.

Another undesirable factor inherent in separate physical storage devices, such as floppy discs or other devices, is the creation of excess waste. When a user saves an electronic copy of a document or file to a floppy disc, the unused portion of the disc is wasted. This represents further waste of the resources used in creating the disc itself.

Printer devices such as ink-jet printers and laser printers have become increasingly more common and specialized in terms of their quality of resolution. Laser printers typically offer improved speed, precision and economy over ink-jet printing. Laser printers tend to be more expensive then ink-jet printers, however, comparatively speaking they are less costly to maintain. Toner powder, as used by laser printers is relatively cheap and lasts a long time, whereas liquid ink cartridges tend to dry up and/or may be used up very quickly. A typical modem laser printer may also print 20+ pages per minute whereas an inkjet printer may only accomplish 7 per minute.

As a direct result of the advances in both laser and ink-jet printing, hard copy versions of data are increasingly more precise and capable of conveying visual information with greater resolution and clarity. To some extent, this leads users to be more prolific in their printing efforts, both for their own use as well as in printing for dissemination to others.

If the user is working with multiple versions of a document, image, picture, or other physically tangible form of the data, the issue of a paper copy and a separate electronic copy may become both complex and confusing. As such, a user may inadvertently open an electronic copy that does not correspond to the print copy he or she is working with. This introduces an opportunity for error within the data as the user makes changes. In addition, there is the prospect of additional time lost in sorting and comparing electronic and hard copies. These issues of lost time and data error potentially carry an economic cost.

Hence, there is a need for a data storage device that overcomes one or more of the drawbacks identified above.

### SUMMARY

The present disclosure advances the art and overcomes problems articulated above by providing a flexible media magnetic laser printing and data storage system.

In particular and by way of example only, according to an embodiment, provided is a flexible media magnetic laser printing system including: a case; a laser printing device disposed at least partially within the case, the laser printer device including a print material applicator and a fuser; at least one reservoir of magnetic print material coupled to the print material applicator, the magnetic print material including magnetic particles capable of supporting high density data; and at least one magnetic write device disposed at least partially within the case proximate to the fuser, opposite from the print material applicator.

### BRIEF DESCRIPTION OF THE DRAWINGS

FIG. 1 is a plan view of a flexible media magnetic laser printing system according to an embodiment;

FIG. 2 is a plan view of a flexible media magnetic laser printing system according to an alternative embodiment;

FIG. 3 is enlarged portion of FIG. 1 illustrating the application of magnetic toner to a flexible media;

FIG. 4 is a further enlarged portion of FIG. 3 detailing the fuser and magnetic write device;

FIG. 5 is a top view of a flexible media receiving magnetic toner according to an embodiment wherein magnetic toner and visible toner are independently applied;

FIG. 6 is a top view of a flexible media receiving magnetic toner according to an alternative embodiment wherein magnetic toner and visible toner are applied together;

FIG. 7 illustrates one relationship of magnetic toner and visible toner according to one embodiment; and

FIG. 8 illustrates an alternative relationship of magnetic toner and visible toner according to an alternative embodiment.

### DETAILED DESCRIPTION

Before proceeding with the detailed description, it is to be appreciated that the present teaching is by way of example, not by limitation. The concepts herein are not limited to use or application with a specific type of flexible media magnetic laser printing system. Thus, although the instrumentalities described herein are for the convenience of explanation, and shown and described with respect to exemplary embodiments, it will be appreciated that the principles herein may be equally applied in other types of flexible media magnetic laser printing. It will be appreciated that the drawings are not necessarily drawn to scale and may be expanded in certain aspects for ease of discussion.

In the following description, the term “data” is understood and appreciated to be represented in various ways depending upon context. Generally speaking, the data at issue is primarily binary in nature, represented as logic “0” and logic “1”. However, it will be appreciated that the binary states in practice may be represented by relatively different voltages, currents, resistances or the like that may be measured, sensed or imposed and it may be a matter of design choice whether a particular practical manifestation of data within a memory element represents a “0” or a “1” or other memory state designation.

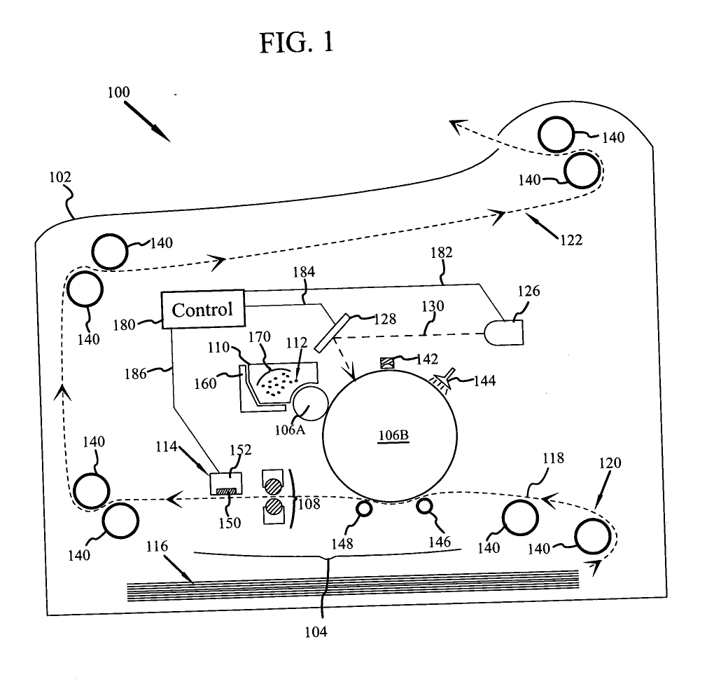

Referring now to the drawings, and more particularly FIG. 1, there is shown a portion of a flexible media magnetic laser printing system 100 according to an embodiment, having a case 102, a laser printing device 104 having at least one print material applicator 106, a fuser 108, at least one reservoir 110 containing magnetic print material 112 coupled to the print material applicator 106, and at least one magnetic write device 114. As described below, print material applicator 106 may include subcomponents such as 106A and 106B.

Magnetic write device 114 is disposed at least partially within case 102 and proximate to the fuser 108. A flexible media 116 is presented to the print material applicator 106 for receiving the magnetic print material 112. More specifically, flexible media 116 is a print material receiving media. In at least one embodiment, the flexible media 116 presented to the print material applicator 106 is paper.

The data recording ability of the flexible media magnetic laser printing system 100 is at least in part achieved by the magnetic print material 112. More specifically, the magnetic print material 112 includes magnetic particles 112 capable of supporting high density data represented as magnetic fields. As such, the magnetic print material 112 provides magnetic data storage when fused to flexible media 116.

In at least one embodiment, the particles capable of supporting high density data are small substantially uniform ferromagnetic particles, such as iron oxide particles. The actual size of the ferromagnetic particles may be determined by data storage requirements, however in at least one embodiment the ferromagnetic particles are less than 100 nm. In at least one embodiment, the magnetic particles may be substantially similar to the magnetic particles commonly found in ferrofluids.

In addition, although the magnetic print material 112 is capable of supporting high density data, the magnetic print material 112 may have a substantially low initial magnetization, but can be influenced to maintain a higher magnetization. Such behavior may be better understood and appreciated with the example of an iron bar. In an initial state, an iron bar may be said to have a low initial magnetization. However, upon exposure to a magnetic field the iron bar may assume a higher level of magnetization. The degree of magnetization is affected in part by the strength, orientation and duration of the applied magnetic field.

The print material commonly used in a laser printing system is typically referred to as toner—a powdery substance typically including pigment and plastic. The pigment is typically black, or a color such as cyan, magenta and/or yellow. The purpose of the pigment is to provide a visual image such as a chart, graph, photo, or text. The pigment is blended with the plastic particles so that the toner will melt when passed through the localized heat provided by fuser 108. As the toner is melted it binds to the flexible media 116 to which it has been applied, such as paper fibers. In at least one embodiment magnetic print material 112 may be combined with plastic or polymer particles to provide a magnetic toner 170. Moreover, the magnetic print material 112 may be bonded to the flexible media 116 by the melting of the plastic or polymer particles as the magnetic toner 170 passes through the fuser 108.

In at least one embodiment, magnetic print material 112 may be combined with traditional laser toner, such as black or colored toner, or provided as or within a separate magnetic toner reservoir, paralleling the use of multiple color toner reservoirs in color laser printing. Moreover, the magnetic print material 112 may be substantially invisible. The visible print material may be black toner, or colored toner.

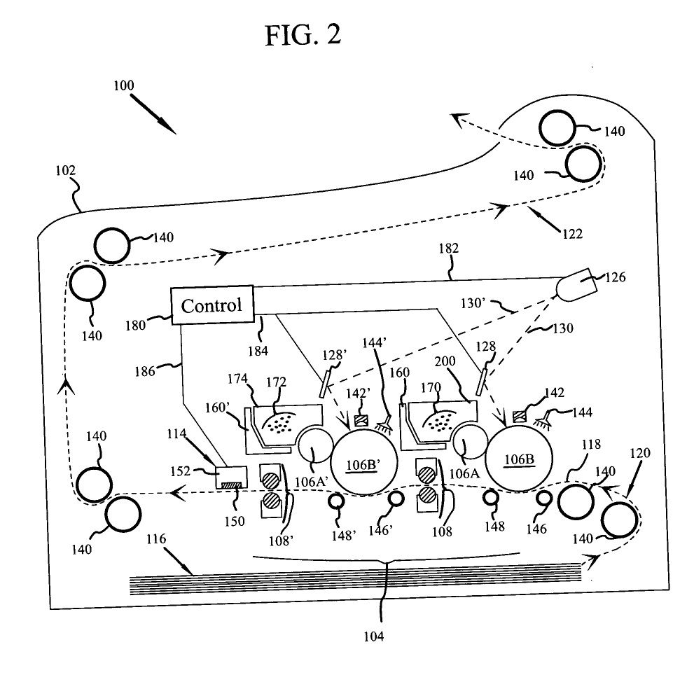

In applications where colored toner is used, the visible colored toner may be a combination of several separate toners, such as for example, Red/Green/Blue or Cyan/Magenta/Yellow, as are commonly used in color laser printing. As the magnetic print material 112 is provided as magnetic toner 170, the same technology used to apply visible toner 172 may be advantageously relied upon for the application of the magnetic toner 170, see FIG. 2 More specifically, controller 180 utilizing control logic and disposed within case 102 communicates with a laser imaging device, herein after laser 126, and or a laser guide 128 through control lines 182 and 184 to control the application of material to flexible media 116 provided by a user, as further described below.

Moreover, as shown in FIG. 2, the visible toner 172 may be provided by at least visible toner reservoir 174, and the magnetic print material 112 may be provided by at least one magnetic toner reservoir 200. In at least one embodiment the reservoir of visible toner 172 and the reservoir of magnetic toner 170 are a combined reservoir 110, as shown in FIG. 1.

FIG. 2 illustrates an embodiment wherein the magnetic print material 112 is provided as separate magnetic toner 170 in one reservoir 200 while a traditional visible toner 172 is provided by a second reservoir 174 The order of application, i.e. magnetic toner before visible toner, or visible toner before magnetic toner, may be interchanged. In at least one embodiment the magnetic toner 170 is applied first so as to be protected by the subsequent application of visible toner 172.

With respect to FIGS. 1 and 2, the flexible media 116 is transported through the case 102 along a flexible media path 118, represented as a dotted line. Flexible media path 118 may be described as having a down stream section 120, and an upstream section 122. The down stream section 120 occurs before any print material (i.e. magnetic toner, visible toner or combined visible magnetic toner) is applied to the flexible media 116. As shown, the media path 118 utilizes a plurality of rollers 140 to deliver the flexible media 116 with applied printing to the top of case 102. Under appropriate circumstances, such as for printing upon thicker material, such as card stock, the media path 118 may include optional output locations, such as for example a front fold down door (not shown). The flexible media path 116 is understood to be exemplary. Under appropriate circumstances, such as where multiple reservoirs are employed (i.e. separate magnetic toner reservoir 110, and visible toner reservoir 174) the flexible media path 116 may provide alternative passage to by-pass un-used or un-desired toner application components.

The principles of laser printing are well understood in the art, and briefly summarized herein for the purposes of discussion with respect to FIGS. 1, 2, 3, 4 and 5. The laser printing device 104 may be generalized to include a device for applying print material to a provided flexible media 116, and a device for bonding the applied print material to the provided flexible media 116. In at least one embodiment, the device applying the print material includes: a magnetic material reservoir 110 coupled to print material applicator 106, a laser 126, a charging device 142, and a discharge lamp 144.

The print material applicator 106 may consist of one or more drums or rollers. As shown in FIGS. 1 and 2, in at least one embodiment, a developer roller 106A and photoconductive drum 106B comprise print material applicator 106. Developer roller 106A is coupled to the reservoir (100, 200) to receive magnetic toner 170 and provide magnetic toner to the photoconductive drum 106B. The photoconductive drum 106B is typically made out of a highly photoconductive material that may be discharged by light photons. In certain embodiments there may be plurality of print material applicators 106, (see FIG. 2) or a single drum may serve to both receive magnetic print material 112 directly from the reservoir 110 and apply magnetic print material 112 to the flexible media 116 (see FIG. 1).

With a laser printing system, typically a single device incorporates the reservoir 110 and one or more print material applicators 106 (i.e. the developer roller 106A and photoconductive drum 106B), into a single device commonly known as a toner cartridge. Moreover, toner cartridges are removable, permitting the user to replace them when and as the toner supply runs low. Removable toner cartridges are aligned to the flexible media path 118 by a toner cartridge receptacle 160 disposed at least partially within case 102. In at least one embodiment, the flexible media magnetic laser printing system 100 includes a plurality of toner cartridge receptacles 160, 160′ for receiving a magnetic toner cartridge and at least one color toner cartridge (i.e., Black/Cyan/Magenta/Yellow), see FIG. 2.

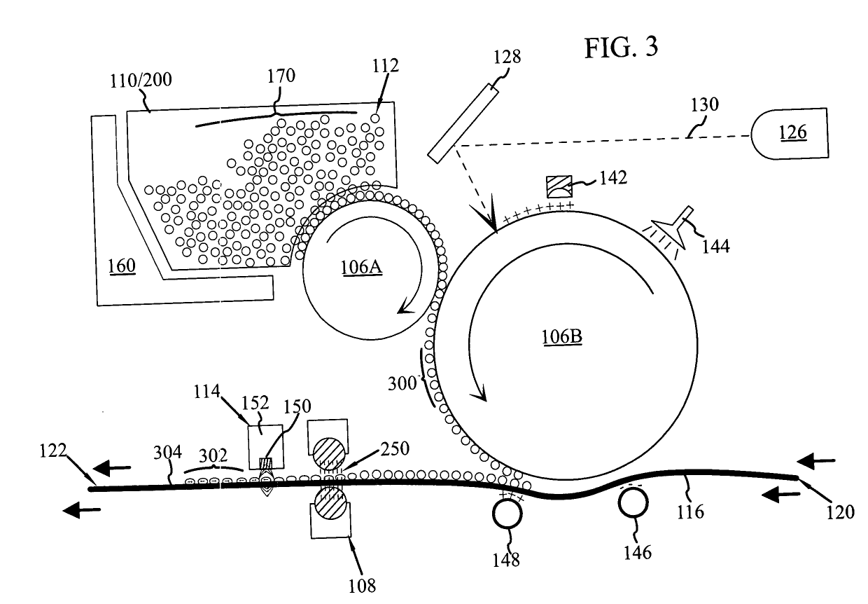

FIG. 3 provides an enlargement illustrating the application of magnetic toner 170 to a flexible media 116. As shown in FIG. 3 a positive charge is applied to the photoconductive drum 106B by the charging device 142, such as a corona wire. Photoconductive drum 106B is disposed within case 102 so as to be optically coupled to laser 126. As photoconductive drum 106B revolves, laser 126 directs a laser beam 130 across the surface to discharge certain locations (take them from a positive charge to a negative charge). Stated another way, the laser 126 draws the desired image, or at least a portion of image, upon the photoconductive drum 106B as an electrostatic image. Magnetic toner 170, (illustrated as circles 300, each including at least one magnetic particle 112) is delivered by the developer roller 106A, to photoconductive drum 106B. As the magnetic print material 112 is positively charged, magnetic print material 112 will generally cling to the discharged (as in negative charged) areas, i.e. the electrostatic image.

Another charging device 146 disposed proximate to media path 118 provides a negative charge to flexible media 116 as it is presented to photoconductive drum 106B. As the negative charge applied to the flexible media 116 is generally stronger then the negative electrostatic charge holding magnetic toner 170 to photoconductive drum 106B, the magnetic toner 170 transfers to the flexible media 116. In at least one embodiment the relationship of the charges is reversed, i.e. photoconductive drum 106B is negatively charged, the electrostatic image provided by laser 126 is a positive charge, the magnetic toner 170 is negatively charged, and the flexible media 116 is given a positive charge.

Moreover, the flexible media magnetic laser printing system 100 is operable during a print operation to apply magnetic toner 170 to flexible media 116 in substantially the same area as to which visible toner 172 is applied. In at least one embodiment, such substantially co-location is accomplished by combining the magnetic toner and visible toner 172 within the same reservoir so that they are simultaneously provided to the same toner delivery roller, for example the photoconductive drum 106B.

To keep the flexible media 116 from clinging to photoconductive drum 106B it is discharged by de-charging device 148 after picking up the print media. In at least one embodiment, charging device 146 is a transfer corona wire or charged roller, and de-charging device 148 is a detac corona wire or de-charging roller.

The fuser 108 is disposed upstream from the print material applicator 106. With respect to embodiments providing at least one toner cartridge receptacle 160 the fuser 108 is generally upstream from these receptacles 160. More specifically, the fuser 108 is upstream from where the toner cartridge receptacle 160 will align a removable toner cartridge to the flexible media path 118 for application of print material. As shown in FIG. 2, where multiple toner reservoirs 110, 110′ are employed, such as with the use of multiple toner cartridges, multiple fusers 108, 108′ may be employed to bond one toner to the flexible media before a subsequent toner is applied.

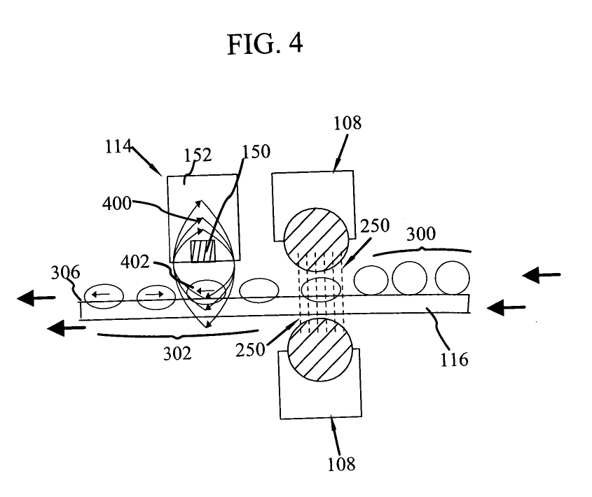

The fuser 108 is typically disposed transverse to the direction of travel along the flexible media path 118. As may be more fully appreciated with respect to FIG. 4, showing an enlargement of the fuser area portion of FIG. 2 or FIG. 3, fuser 108 provides localized heat 250, illustrated as dotted lines, to the flexible media 116.

The toner particles, be they visible, magnetic or a combination, are represented in their unheated state as circles 300. As these particles are subjected to heat 250 from fuser 108, the toner particles melt and bond with the flexible media 116. Such melting and bonding is illustrated by the circles 300 becoming ovals 302, at least a portion of each oval melding into the flexible media, illustrated as a portion of each oval being below the top surface 306 of the flexible media 116, see FIG. 4.

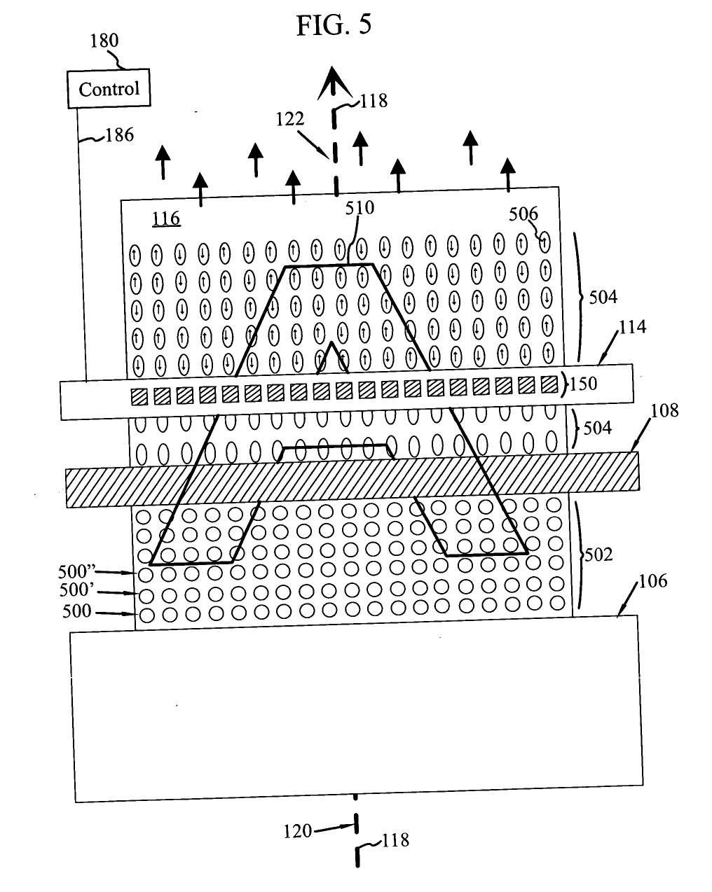

As shown in FIG. 5, for the purposes of later scanning the flexible media to read the magnetically encoded data, in at least one embodiment the magnetic toner 170 is applied as parallel tracks 500. However, under appropriate circumstances, the magnetic toner 170 may be applied so as to ultimately produce a circle, or other object.

The precision of laser control permits the magnetic toner 170 to be applied as individual dots 502 at a predetermined interval spacing, the spacing selected to avoid the magnetic toner dots from joining together. The predetermined spacing and size of the individual dots serves to predefine the storage format. In an alternative embodiment the application of the magnetic toner 170 to the flexible media 116 may be performed so as to create a continuous strip of magnetic material across the surface of the flexible media 116.

In at least one embodiment, the magnetic write device 114 is a linear array of magnetic field providers 150 disposed proximate to the flexible media path 118. Specifically, magnetic write device 114 is disposed upstream from the fuser 108. In the case of multiple fusers 108, 108′ as shown in FIG. 2, the magnetic write device 114 is disposed upstream from the most upstream fuser 108.

Each magnetic field provider 150 is operable to provide an oriented magnetic field of a threshold intensity, sufficient to orient, or create an oriented magnetic field within the magnetic particles of the applied magnetic toner 170. FIG. 4 illustrates such an oriented magnetic field as looping arrows 400. As the magnetic field in contact with the magnetic toner particle represented by oval 402 is oriented towards the left, the magnetic field of magnetic toner particle 402 is oriented towards the left as well. In an alternative embodiment, magnetic write device may be a movable magnetic write head operable to move transversely across the flexible media path 118. Use of a linear array of magnetic field providers 150 is preferred in at least one embodiment as such a linear array permits an entire line of magnetic toner 170 to be encoded simultaneously.

In addition, in at least one embodiment, the plurality of is a magnetic field providers 150 operate simultaneously. Such contemporaneous operation is facilitated by orienting magnetic write device 114 transverse to the flexible media path 118, as shown in FIG. 5. A controller 180 utilizing control logic is coupled to magnetic write device 114 by control line 186. As shown in FIGS. 1 and 2, a single integrated controller 180 may control both the magnetic write device 114, as well as the laser 126 and laser guides 128, 128′, or separate controllers may be provided. In at least one embodiment, the magnetic write device 114 may be shielded, such as for example with lead or other magnetically shielding material such as a cladding 152.

In at least one embodiment the magnetic field providers 150 may be devices such as a magneto-resistive head or giant magneto-resistance heads. Such types of devices are commonly found within a typical hard drive as a read/write head and well understood in the field of data storage technology. The read functionality of a read/write device used in a hard drive may not be utilized in the flexible media magnetic laser printing system 100, however use of such off the shelf heads may be desirable as a cost saving measure during fabrication.

Typically, hard drive read/write devices provide a single head with two independent circuits—one for reading and one for writing. Under appropriate circumstances, the read and write circuits may be divided and either may be disabled during fabrication of the incorporating device. Briefly stated, the principle underlying the storage of data in magnetic media is the ability to change and/or reverse the relative orientation of magnetization of a storage bit (i.e. the logic state of a “0” or a “1”).

A given magnetic particle generally has two magnetic axes—a hard axis transverse to an easy axis. The orientation of magnetization tends to prefer alignment along the easy axis. A convention is established to define an first orientation along the easy axis as a “0” and an opposite orientation along the easy axis as a “1”. A magnetic bit is written to a magnetic particle or group of particles by providing a magnetic field of sufficient intensity to re-orient the magnetic alignment to a known direction.

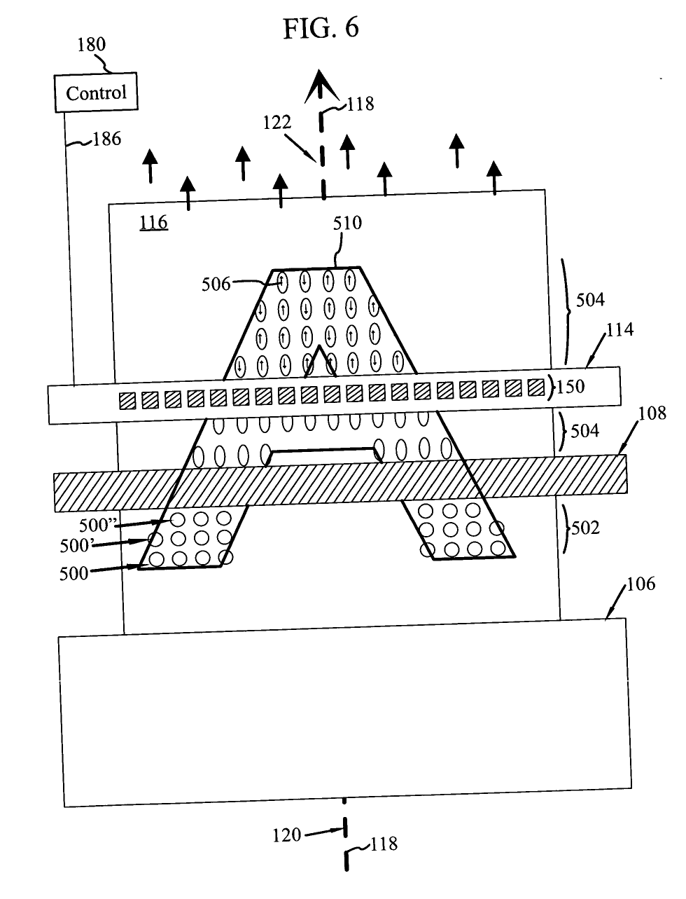

FIGS. 5 and 6 illustrates a partial top view of flexible media 116 passing along media path 118 from print material applicator 106, by fuser 108, and magnetic write device 114. The nature of magnetic write device 114 in at least one embodiment as a being a linear array of magnetic field providers 150 may also be appreciated. For ease of discussion, the scale of the components has been exaggerated.

Applied magnetic toner particles are represented initially as circles 502. Upon heating by the fuser 108 to fuse with flexible media 116 they are transformed to ovals 504. It is understood and appreciated that each magnetic toner circle 502, and oval 504, may include a plurality of magnetic particles 112. Each circle 502 and oval 504 is intended to represent a magnetic media that may be suitable for the storage of a single data bit. The magnetic orientation of each oval 504 is set by magnetic write device 114, the orientation within each oval 504 is illustratively shown by an arrow 506.

In both FIGS. 5 and 6, visual character 510 has not been filled in. FIG. 5 illustrates an embodiment where magnetic toner 170 may be applied independently from typical visual toner 172, showing the magnetic toner 170 applied across the flexible media 116. FIG. 6 illustrates an embodiment where the magnetic toner 170 may be applied in a combined form with typical visual toner 172.

In initial form, the magnetic print material 112 within the magnetic toner 170 may have a low initial magnetization, but can be influenced to maintain a higher magnetization. Alternatively, the magnetic print material 112 may have an established field of an unspecified orientation. As the orientation is not set, or not strongly present, it is not shown in ovals 504 or circles 502 prior to the magnetic write device 114.

The coercivity of a material is the level of magnetizing force, measured in oersteds or ampere-turns per meter, that must be applied to a magnetic particle to reduce and/or reverse the magnetization of the particle. Generally, the smaller a particle the higher the coercivity. The threshold intensity of the magnetic field provided by each magnetic field provider 150 is preset overcome the coercivity of the magnetic print material, so as to establish a known magnetic orientation of preference.

It is generally appreciated in the magnetic memory arts that as the size of a magnetic bit decreases, the coercivity of the bit will increase. For example, a 0.25×0.75 micrometer bit may have a coercivity of about 40 Oe[1 Oe=1000/(4*pi)A/m], whereas a 0.15×0.45 micrometer bit may have a coercivity of about 75 Oe[1 Oe=1000/(4*pi)A/m]. In general, the coercivity of a material will decrease as temperature increase. For example a 100 degrees Celsius rise in temperature may impart a drop in coercivity of about 50%. Upon a decrease in temperature to the original state, the original coercivity will generally return.

As stated above, the fuser 108 melts the toner particles to “fuse” them with the flexible media 116. A typical operating temperature range for a fuser 108 is about 150° C. to 170° C., such that the temperature of the flexible media leaving the fuser is about 160° C. In at least one embodiment the magnetic write device 114 is disposed close to fuser 108, such that the fuser thermally assists magnetic write device 114. More specifically, the flexible media magnetic laser printing system 100 is operable during a print operation such that magnetic toner 170 applied to flexible media 116 is heated by the fuser to fuse the magnetic toner 170 to the media 116, the applied heat thermally assisting the magnetic write device to write data to the fused magnetic toner.

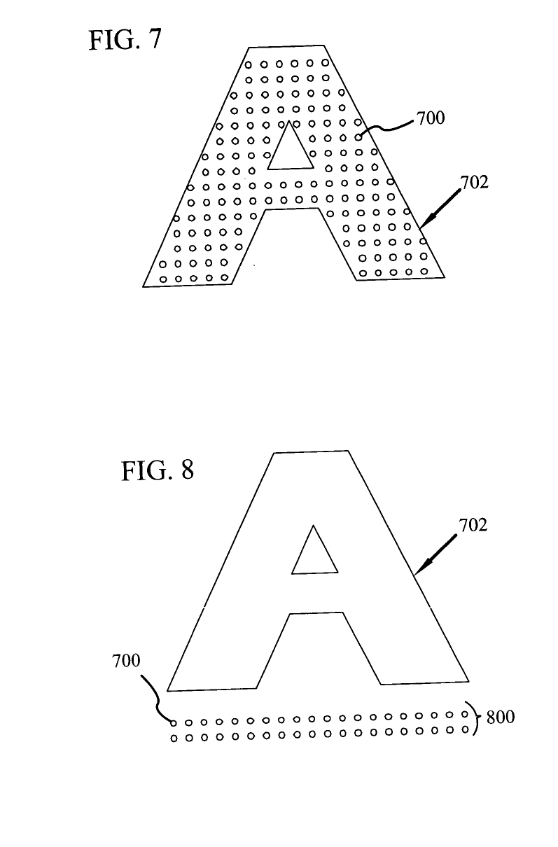

As shown in FIG. 7, magnetic toner dots 700 (formed of magnetic toner 170) have been set down substantially within a visible character 702. For the sake of understanding the placement of the magnetic toner dots 700, visible character 702 has not been substantially filled in or otherwise shaded within the character defining border.

Such co-location of visible and magnetic toner 170 advantageously permits the data storage capability of the flexible media 116 to be substantially non-evident to the eye of a party visually observing the media. Additionally, protection of stored data is advantageously provided when magnetic toner dots 700 are set down beneath a layer or coating of visible toner 172.

In an alternative embodiment shown in FIG. 8, in addition to or as an alternative, the magnetic toner dots 700 are shown as appearing below a text character in a strip 800. In at least one embodiment, such strip 800 may be provided and visually indicated to help inform the user as to the presence of encoded data, or at the very least, the ability to provide encoded data within the flexible media 116.

The representation of the magnetic toner dots 700 as round dots is not intended to suggest or imply that the magnetic toner dots 700 should be substantially round in all cases. Under appropriate circumstances, such as for example to accommodate data strings of certain lengths, the separate magnetic toner dots 700 may be oval, tapered, rectangular or otherwise appropriately shaped. In addition, although illustrated as separate magnetic toner dots 700, it may be desirable for certain applications to provide a continuous strip, or large area of any particular shape of magnetic toner 170. In further addition, it is understood as well that simply because magnetic toner 170 has been applied to flexible media 116, it may be desirable for the magnetic write device 114 to not write any data at all—rather a user may simply desire to create a flexible media that is ready to receive magnetic encoded data at a future date.

Where the magnetic toner dots 700 are intended to be invisible, and not merely concealed by visible toner 172, the type of magnetic print material 112 may impose size restrictions upon the size of the magnetic toner dots 700 and the density of the magnetic toner dots 700. In other words, if the physical size of the magnetic toner dots 700, and/or the density of the magnetic toner dots 700 is significantly increased, visibility of the magnetic toner 170 may occur.

In a similar fashion, the applied magnetic toner 170 may be specifically concentrated in or as a graphic. Moreover, just as visible toner 172 may be applied to render a photograph, page of text, chart or other image, the application of the magnetic toner 170 to flexible media 116 is in general limited only by the physical limitations of the flexible magnetic laser printing system 100.

Advances in magnetic particle fabrication and magnetic read/write devices now permit the storage of data at a nano-scaled level. Such minute granularity may not generally be necessary with respect to flexible media 116 such as paper.

The selection of appropriately sized magnetic particles and the density of these particles within the toner is generally driven by the density of data storage desired. In general, the particle size and density will be sufficient such that each typical 12 point character of Times New Roman text can store 1 to 2 bytes of information. Under appropriate circumstances, this storage capacity may be increased or decreased as required for specific applications.

The use of flexible media such as traditional paper may provide many advantages to users of the flexible media magnetic laser printing system 100. For example, the user need not buy a floppy disc or other physical device on which to store the soft copy of the data. A user can quite literally print himself or herself a floppy when and as needed.

Even more advantageously, the soft copy of the data and the hard copy of the data may be integrated into a single physical item, thus significantly reducing if not otherwise eliminating the opportunity for confusion to arise in matching electronic copies to hard paper copies. In addition, if the user has the hard copy, then by implication, he or she also has the soft copy. Waste of resources is also curtailed as additional resources are not required for a separate data storage device.

Such integration of electronic data and visual data may be most advantageous. Photographs may be printed that also include the necessary data for immediate reproduction without loss of resolution or complex processing. A sheet of music may contain a writing of the score along with the visual notes. A photo of an animal may contain an audio track of the animal in the wild, thereby permitting a user to further enhance his or her learning process beyond what mere text and pictures can provide.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

I claim:

1. A flexible media magnetic laser printing system comprising:
a case;
a laser printing device disposed at least partially within the case, the laser printer device including a print material applicator and a fuser;
at least one reservoir of magnetic print material coupled to the print material applicator, the magnetic print material including magnetic particles capable of supporting high density data; and
at least one magnetic write device disposed at least partially within the case proximate to the fuser, opposite from the print material applicator.

2. The flexible media magnetic laser printing system of claim 1, wherein the magnetic print material comprises magnetic toner.

3. The flexible media magnetic laser printing system of claim 1, wherein the fuser is operable to thermally assist the at least one magnetic write device.

4. The flexible media magnetic laser printing system of claim 1, wherein the at least one magnetic write device is a linear array of magnetic field providers.

5. The flexible media magnetic laser printing system of claim 1, wherein the flexible media is paper or cloth.

6. A flexible media magnetic laser printing system comprising:
a case;
a laser disposed within the case;
at least one print material applicator optically coupled to the laser;
at least one reservoir of visible toner coupled to the at least one print material applicator;
at least one reservoir of magnetic toner coupled to the at least one print material applicator, the magnetic toner including magnetic particles capable of supporting high density data;
a fuser disposed within the case proximate to the at least one print material applicator; and
at least one magnetic write device disposed within the case proximate to the fuser, opposite from the at least one print material applicator.

7. The flexible media magnetic laser printing system of claim 6, wherein the print material applicator includes a developer roller and a photoreceptor drum.

8. The flexible media magnetic laser printing system of claim 6, wherein print material applied by the print material applicator is toner.

9. The flexible media magnetic laser printing system of claim 6, wherein the at least one print material applicator, fuser and at least one magnetic write device form a media path to deliver flexible media presented to the at least one print material applicator, through the fuser and past the at least one magnetic write device.

10. The flexible media magnetic laser printing system of claim 6, wherein the same at least one print material applicator receiving visible toner also receives magnetic toner.

11. The flexible media magnetic laser printing system of claim 6, wherein the reservoir of visible toner and the reservoir of magnetic toner are a combined reservoir.

12. The flexible media magnetic laser printing system of claim 6, wherein the at least one magnetic write device is a linear array of magnetic field providers, each magnetic field provider operable to provide an oriented magnetic field of a threshold intensity.

13. The flexible media magnetic laser printing system of claim 6, wherein the printer is operable during a print operation such that magnetic toner is applied to a flexible media in substantially the same area as to which visible toner is applied.

14. The flexible media magnetic laser printing system of claim 6, wherein the printer is operable during a print operation such that magnetic toner applied to a flexible media is heated by the fuser to fuse to the flexible media, the applied heat thermally assisting the at least one magnetic write device to write data to the fused magnetic toner.

15. The flexible media magnetic laser printing system of claim 6, wherein the magnetic toner is substantially invisible.

16. The flexible media magnetic laser printing system of claim 6, wherein the printer is operable to apply magnetic toner to a flexible media as individual dots at a predetermined interval spacing, the spacing selected to substantially avoid the magnetic toner dots joining together.

17. The flexible media magnetic laser printing system of claim 6, wherein a removable toner cartridge comprises at least one print material applicator and reservoir of magnetic toner.

18. The flexible media magnetic laser printing system of claim 6, further including a flexible media set to receive magnetic toner as applied by the at least one print material applicator.

19. A flexible media magnetic laser printing system comprising:
a case;
a flexible media path through the case, the paper path having a down stream section and an upstream section;
at least one toner cartridge receptacle disposed within the case, adjacent to the flexible media path;
a fuser disposed within the case adjacent to the flexible media path, upstream from the toner cartridge receptacle;
a magnetic write device disposed within the case adjacent to the flexible media path, upstream from the fuser;
a laser imaging device disposed with the case; and
at least one removable toner cartridge removably coupled to the toner cartridge receptacle and optically coupled to the laser imaging device, the cartridge including:
a print material applicator;
at least one toner reservoir coupled to the print material applicator, the reservoir containing magnetic toner including magnetic particles capable of supporting high density data.

20. The flexible media magnetic laser printing system of claim 19, wherein the removable toner cartridge further comprises magnetic toner and color toner.

21. The flexible media magnetic laser printing system of claim 19, further including a plurality of toner cartridge receptacles for receiving a magnetic toner cartridge and at least one color toner cartridge.

22. The flexible media magnetic laser printing system of claim 19, wherein the printer is operable during a print operation such that magnetic toner is applied to a flexible media in substantially the same area as to which visible toner is applied.

23. The flexible media magnetic laser printing system of claim 19, wherein the printer is operable during a print operation such that magnetic toner applied to a flexible media is heated by the fuser to fuse to the ink receiving media, the applied heat thermally assisting the at least one magnetic write device to write data to the fused magnetic toner.

24. The flexible media magnetic laser printing system of claim 19, wherein the at least one magnetic write device is a linear array of magnetic field providers, each magnetic field provider operable to provide an oriented magnetic field of a threshold intensity.

25. A flexible media magnetic laser printing system comprising:
a case;
a laser imaging device disposed with the case;
a flexible media path through the case, the paper path having a down stream section and an upstream section;
at least one toner cartridge receptacle disposed within the case, adjacent to the flexible media path;
a fuser disposed within the case adjacent to the flexible media path, upstream from the toner cartridge receptacle; and
a magnetic write device disposed within the case adjacent to the flexible media path, upstream from the fuser; the fuser thermally assisting the magnetic write device.

26. The flexible media magnetic laser printing system of claim 25, further including at least one removable toner cartridge removably coupled to the toner cartridge receptacle and optically coupled to the laser imaging device, the cartridge including:
a print material applicator;
at least one toner reservoir coupled to the print material applicator, the reservoir containing magnetic toner including magnetic particles capable of supporting high density data.

27. The flexible media magnetic laser printing system of claim 25, further including a plurality of toner cartridge receptacles for receiving a magnetic toner cartridge and at least one color toner cartridge.

28. The flexible media magnetic laser printing system of claim 25, wherein the at least one magnetic write device is a linear array of magnetic field providers, each magnetic field provider operable to provide an oriented magnetic field of a threshold intensity.

29. The flexible media magnetic laser printing system of claim 25, wherein the flexible media is paper or cloth.
